SEQUENCE LISTING (200 sequences)

SEQ ID NO: 1 - DNA, 30 bp, Artificial Sequence
  Description of Artificial Sequence Synthetic HPV18 probe
tgcttctacacagtctcctgtacctgggca

SEQ ID NO: 2 - DNA, 30 bp, Artificial Sequence
  Description of Artificial Sequence Synthetic HPV33 probe
caaggtcataataatggtatttgttggggc

SEQ ID NO: 3 - DNA, 30 bp, Artificial Sequence
  Description of Artificial Sequence Synthetic HPV58 probe
aggtcatccgggacagcctcgccaagtttt

SEQ ID NO: 4 - DNA, 30 bp, Artificial Sequence
  Description of Artificial Sequence Synthetic HPV68 probe
agtagttatgtatatgccccctcgcctagt

SEQ ID NO: 5 - DNA, 30 bp, Artificial Sequence
  Description of Artificial Sequence Synthetic HIV probe
ggtctctctggttagaccagatctgagcct

SEQ ID NO: 6 - DNA, 30 bp, Artificial Sequence
  Description of Artificial Sequence Synthetic HIV probe
gggagctctctggctaactagggaacccac

SEQ ID NO: 7 - DNA, 30 bp, Artificial Sequence
  Description of Artificial Sequence Synthetic HIV probe
tgcttaagcctcaataaagcttgccttgag

SEQ ID NO: 8 - DNA, 30 bp, Artificial Sequence
  Description of Artificial Sequence Synthetic HIV probe
tgcttcaagtagtgtgtgcccgtctgttgt

SEQ ID NO: 9 - DNA, 30 bp, Artificial Sequence
  Description of Artificial Sequence Synthetic HIV probe
gtgactctggtaactagagatccctcagac

SEQ ID NO: 10 - DNA, 30 bp, Artificial Sequence
  Description of Artificial Sequence Synthetic HIV probe
ccttttagtcagtgtggaaaatctctagca

SEQ ID NO: 11 - DNA, 30 bp, Artificial Sequence
  Description of Artificial Sequence Synthetic HIV probe
gtggcgcccgaacagggacctgaaagcgaa

SEQ ID NO: 12 - DNA, 30 bp, Artificial Sequence
  Description of Artificial Sequence Synthetic HIV probe
agggaaaccagaggagctctctcgacgcag

SEQ ID NO: 13 - DNA, 30 bp, Artificial Sequence
  Description of Artificial Sequence Synthetic HIV probe
gactcggcttgctgaagcgcgcacggcaag

SEQ ID NO: 14 - DNA, 30 bp, Artificial Sequence
  Description of Artificial Sequence Synthetic HIV probe
aggcgaggggcggcgactggtgagtacgcc

SEQ ID NO: 15 - DNA, 30 bp, Artificial Sequence
  Description of Artificial Sequence Synthetic HIV probe
aaaaattttgactagcggaggctagaagga

SEQ ID NO: 16 - DNA, 30 bp, Artificial Sequence
  Description of Artificial Sequence Synthetic HIV probe
gagagatgggtgcgagagcgtcagtattaa

SEQ ID NO: 17 - DNA, 30 bp, Artificial Sequence
  Description of Artificial Sequence Synthetic HIV probe
gcgggggagaattagatcgatgggaaaaaa

SEQ ID NO: 18 - DNA, 30 bp, Artificial Sequence
  Description of Artificial Sequence Synthetic HIV probe
ttcggttaaggccagggggaaagaaaaaat

SEQ ID NO: 19 - DNA, 30 bp, Artificial Sequence
  Description of Artificial Sequence Synthetic HIV probe
ataaattaaaacatatagtatgggcaagca

SEQ ID NO: 20 - DNA, 30 bp, Artificial Sequence
  Description of Artificial Sequence Synthetic HIV probe
gggagctagaacgattcgcagttaatcctg

SEQ ID NO: 21 - DNA, 30 bp, Artificial Sequence
  Description of Artificial Sequence Synthetic HIV probe
gcctgttagaaacatcagaaggctgtagac

SEQ ID NO: 22 - DNA, 30 bp, Artificial Sequence
  Description of Artificial Sequence Synthetic HIV probe
aaatactgggacagctacaaccatcccttc

SEQ ID NO: 23 - DNA, 30 bp, Artificial Sequence
  Description of Artificial Sequence Synthetic HIV probe
agacaggatcagaagaacttagatcattat

SEQ ID NO: 24 - DNA, 30 bp, Artificial Sequence
  Description of Artificial Sequence Synthetic HIV probe
ataatacagtagcaaccctctattgtgtgc

SEQ ID NO: 25 - DNA, 30 bp, Artificial Sequence
  Description of Artificial Sequence Synthetic HIV probe
atcaaaggatagagataaaagacaccaagg

SEQ ID NO: 26 - DNA, 30 bp, Artificial Sequence
  Description of Artificial Sequence Synthetic HIV probe
aagctttagacaagatagaggaagagcaaa

SEQ ID NO: 27 - DNA, 30 bp, Artificial Sequence
  Description of Artificial Sequence Synthetic HIV probe
acaaaagtaagaaaaaagcacagcaagcag

SEQ ID NO: 28 - DNA, 30 bp, Artificial Sequence
  Description of Artificial Sequence Synthetic HIV probe
cagctgacacaggacacagcaatcaggtca

SEQ ID NO: 29 - DNA, 30 bp, Artificial Sequence
  Description of Artificial Sequence Synthetic HIV probe
gccaaaattaccctatagtgcagaacatcc

SEQ ID NO: 30 - DNA, 30 bp, Artificial Sequence
  Description of Artificial Sequence Synthetic HIV probe
aggggcaaatggtacatcaggccatatcac

SEQ ID NO: 31 - DNA, 30 bp, Artificial Sequence
  Description of Artificial Sequence Synthetic HIV probe
ctagaactttaaatgcatgggtaaaagtag

SEQ ID NO: 32 - DNA, 30 bp, Artificial Sequence
  Description of Artificial Sequence Synthetic HIV probe
tagaagagaaggctttcagcccagaagtga

SEQ ID NO: 33 - DNA, 30 bp, Artificial Sequence
  Description of Artificial Sequence Synthetic HIV probe
tacccatgttttcagcattatcagaaggag

SEQ ID NO: 34 - DNA, 30 bp, Artificial Sequence
  Description of Artificial Sequence Synthetic HIV probe
ccaccccacaagatttaaacaccatgctaa

SEQ ID NO: 35 - DNA, 30 bp, Artificial Sequence
  Description of Artificial Sequence Synthetic HIV probe
acacagtggggggacatcaagcagccatgc

SEQ ID NO: 36 - DNA, 30 bp, Artificial Sequence
  Description of Artificial Sequence Synthetic HIV probe
aaatgttaaaagagaccatcaatgaggaag

SEQ ID NO: 37 - DNA, 30 bp, Artificial Sequence
  Description of Artificial Sequence Synthetic HIV probe
ctgcagaatgggatagagtgcatccagtgc

SEQ ID NO: 38 - DNA, 30 bp, Artificial Sequence
  Description of Artificial Sequence Synthetic HIV probe
atgcagggcctattgcaccaggccagatga

SEQ ID NO: 39 - DNA, 30 bp, Artificial Sequence
  Description of Artificial Sequence Synthetic HIV probe
gagaaccaaggggaagtgacatagcaggaa

SEQ ID NO: 40 - DNA, 30 bp, Artificial Sequence
  Description of Artificial Sequence Synthetic HIV probe
ctactagtacccttcaggaacaaataggat

SEQ ID NO: 41 - DNA, 30 bp, Artificial Sequence
  Description of Artificial Sequence Synthetic HIV probe
ggatgacaaataatccacctatcccagtag

SEQ ID NO: 42 - DNA, 30 bp, Artificial Sequence
  Description of Artificial Sequence Synthetic HIV probe
gagaaatttataaaagatggataatcctgg

SEQ ID NO: 43 - DNA, 30 bp, Artificial Sequence
  Description of Artificial Sequence Synthetic HIV probe
gattaaataaaatagtaagaatgtatagcc

SEQ ID NO: 44 - DNA, 30 bp, Artificial Sequence
  Description of Artificial Sequence Synthetic HIV probe
ctaccagcattctggacataagacaaggac

SEQ ID NO: 45 - DNA, 30 bp, Artificial Sequence
  Description of Artificial Sequence Synthetic HIV probe
caaaggaaccctttagagactatgtagacc

SEQ ID NO: 46 - DNA, 30 bp, Artificial Sequence
  Description of Artificial Sequence Synthetic HIV probe
ggttctataaaactctaagagccgagcaag

SEQ ID NO: 47 - DNA, 30 bp, Artificial Sequence
  Description of Artificial Sequence Synthetic HIV probe
cttcacaggaggtaaaaaattggatgacag

SEQ ID NO: 48 - DNA, 30 bp, Artificial Sequence
  Description of Artificial Sequence Synthetic HIV probe
aaaccttgttggtccaaaatgcgaacccag

SEQ ID NO: 49 - DNA, 30 bp, Artificial Sequence
  Description of Artificial Sequence Synthetic HIV probe
attgtaagactattttaaaagcattgggac

SEQ ID NO: 50 - DNA, 30 bp, Artificial Sequence
  Description of Artificial Sequence Synthetic HIV probe
cagcggctacactagaagaaatgatgacag

SEQ ID NO: 51 - DNA, 30 bp, Artificial Sequence
  Description of Artificial Sequence Synthetic HIV probe
catgtcagggagtaggaggacccggccata

SEQ ID NO: 52 - DNA, 30 bp, Artificial Sequence
  Description of Artificial Sequence Synthetic HIV probe
aggcaagagttttggctgaagcaatgagcc

SEQ ID NO: 53 - DNA, 30 bp, Artificial Sequence
  Description of Artificial Sequence Synthetic HIV probe
aagtaacaaattcagctaccataatgatgc

SEQ ID NO: 54 - DNA, 30 bp, Artificial Sequence
  Description of Artificial Sequence Synthetic HIV probe
agagaggcaattttaggaaccaaagaaaga

SEQ ID NO: 55 - DNA, 30 bp, Artificial Sequence
  Description of Artificial Sequence Synthetic HIV probe
ttgttaagtgtttcaattgtggcaaagaag

SEQ ID NO: 56 - DNA, 30 bp, Artificial Sequence
  Description of Artificial Sequence Synthetic HIV probe
ggcacacagccagaaattgcagggccccta

SEQ ID NO: 57 - DNA, 30 bp, Artificial Sequence
  Description of Artificial Sequence Synthetic HIV probe
ggaaaaagggctgttggaaatgtggaaagg

SEQ ID NO: 58 - DNA, 30 bp, Artificial Sequence
  Description of Artificial Sequence Synthetic HIV probe
aaggacaccaaatgaaagattgtactgaga

SEQ ID NO: 59 - DNA, 30 bp, Artificial Sequence
  Description of Artificial Sequence Synthetic HIV probe
gacaggctaattttttagggaagatctggc

SEQ ID NO: 60 - DNA, 30 bp, Artificial Sequence
  Description of Artificial Sequence Synthetic HIV probe
cttcctacaagggaaggccagggaattttc

SEQ ID NO: 61 - DNA, 30 bp, Artificial Sequence
  Description of Artificial Sequence Synthetic HIV probe
ttcagagcagaccagagccaacagccccac

SEQ ID NO: 62 - DNA, 30 bp, Artificial Sequence
  Description of Artificial Sequence Synthetic HIV probe
cagaagagagcttcaggtctggggtagaga

SEQ ID NO: 63 - DNA, 30 bp, Artificial Sequence
  Description of Artificial Sequence Synthetic HIV probe
caacaactccccctcagaagcaggagccga

SEQ ID NO: 64 - DNA, 30 bp, Artificial Sequence
  Description of Artificial Sequence Synthetic HIV probe
tagacaaggaactgtatcctttaacttccc

SEQ ID NO: 65 - DNA, 30 bp, Artificial Sequence
  Description of Artificial Sequence Synthetic HIV probe
tcaggtcactctttggcaacgacccctcgt

SEQ ID NO: 66 - DNA, 30 bp, Artificial Sequence
  Description of Artificial Sequence Synthetic HIV probe
cacaataaagataggggggcaactaaagga

SEQ ID NO: 67 - DNA, 30 bp, Artificial Sequence
  Description of Artificial Sequence Synthetic HIV probe
agctctattagatacaggagcagatgatac

SEQ ID NO: 68 - DNA, 30 bp, Artificial Sequence
  Description of Artificial Sequence Synthetic HIV probe
agtattagaagaaatgagtttgccaggaag

SEQ ID NO: 69 - DNA, 30 bp, Artificial Sequence
  Description of Artificial Sequence Synthetic HIV probe
atggaaaccaaaaatgatagggggaattgg

SEQ ID NO: 70 - DNA, 30 bp, Artificial Sequence
  Description of Artificial Sequence Synthetic HIV probe
aggttttatcaaagtaagacagtatgatca

SEQ ID NO: 71 - DNA, 30 bp, Artificial Sequence
  Description of Artificial Sequence Synthetic HIV probe
gatactcatagaaatctgtggacataaagc

SEQ ID NO: 72 - DNA, 30 bp, Artificial Sequence
  Description of Artificial Sequence Synthetic HIV probe
tataggtacagtattagtaggacctacacc

SEQ ID NO: 73 - DNA, 30 bp, Artificial Sequence
  Description of Artificial Sequence Synthetic HIV probe
tgtcaacataattggaagaaatctgttgac

SEQ ID NO: 74 - DNA, 30 bp, Artificial Sequence
  Description of Artificial Sequence Synthetic HIV probe
tcagattggttgcactttaaattttcccat

SEQ ID NO: 75 - DNA, 30 bp, Artificial Sequence
  Description of Artificial Sequence Synthetic HIV probe
tagccctattgagactgtaccagtaaaatt

SEQ ID NO: 76 - DNA, 30 bp, Artificial Sequence
  Description of Artificial Sequence Synthetic HIV probe
aaagccaggaatggatggcccaaaagttaa

SEQ ID NO: 77 - DNA, 30 bp, Artificial Sequence
  Description of Artificial Sequence Synthetic HIV probe
acaatggccattgacagaagaaaaaataaa

SEQ ID NO: 78 - DNA, 30 bp, Artificial Sequence
  Description of Artificial Sequence Synthetic HIV probe
agcattagtagaaatttgtacagagatgga

SEQ ID NO: 79 - DNA, 30 bp, Artificial Sequence
  Description of Artificial Sequence Synthetic HIV probe
aaaggaagggaaaatttcaaaaattgggcc

SEQ ID NO: 80 - DNA, 30 bp, Artificial Sequence
  Description of Artificial Sequence Synthetic HIV probe
tgaaaatccatacaatactccagtatttgc

SEQ ID NO: 81 - DNA, 30 bp, Artificial Sequence
  Description of Artificial Sequence Synthetic HIV probe
cataaagaaaaaagacagtactaaatggag

SEQ ID NO: 82 - DNA, 30 bp, Artificial Sequence
  Description of Artificial Sequence Synthetic HIV probe
aaaattagtagatttcagagaacttaataa

SEQ ID NO: 83 - DNA, 30 bp, Artificial Sequence
  Description of Artificial Sequence Synthetic HIV probe
gagaactcaagacttctgggaagttcaatt

SEQ ID NO: 84 - DNA, 30 bp, Artificial Sequence
  Description of Artificial Sequence Synthetic HIV probe
aggaataccacatcccgcagggttaaaaaa

SEQ ID NO: 85 - DNA, 30 bp, Artificial Sequence
  Description of Artificial Sequence Synthetic HIV probe
gaaaaaatcagtaacagtactggatgtggg

SEQ ID NO: 86 - DNA, 30 bp, Artificial Sequence
  Description of Artificial Sequence Synthetic HIV probe
tgatgcatatttttcagttcccttagatga

SEQ ID NO: 87 - DNA, 30 bp, Artificial Sequence
  Description of Artificial Sequence Synthetic HIV probe
agacttcaggaagtatactgcatttaccat

SEQ ID NO: 88 - DNA, 30 bp, Artificial Sequence
  Description of Artificial Sequence Synthetic HIV probe
acctagtataaacaatgagacaccagggat

SEQ ID NO: 89 - DNA, 30 bp, Artificial Sequence
  Description of Artificial Sequence Synthetic HIV probe
tagatatcagtacaatgtgcttccacaggg

SEQ ID NO: 90 - DNA, 30 bp, Artificial Sequence
  Description of Artificial Sequence Synthetic HIV probe
atggaaaggatcaccagcaatattccaaag

SEQ ID NO: 91 - DNA, 30 bp, Artificial Sequence
  Description of Artificial Sequence Synthetic HIV probe
tagcatgacaaaaatcttagagccttttag

SEQ ID NO: 92 - DNA, 30 bp, Artificial Sequence
  Description of Artificial Sequence Synthetic HIV probe
aaaacaaaatccagacatagttatctatca

SEQ ID NO: 93 - DNA, 30 bp, Artificial Sequence
  Description of Artificial Sequence Synthetic HIV probe
atacatggatgatttgtatgtaggatctga

SEQ ID NO: 94 - DNA, 30 bp, Artificial Sequence
  Description of Artificial Sequence Synthetic HIV probe
cttagaaatagggcagcatagaacaaaaat

SEQ ID NO: 95 - DNA, 30 bp, Artificial Sequence
  Description of Artificial Sequence Synthetic HIV probe
agaggagctgagacaacatctgttgaggtg

SEQ ID NO: 96 - DNA, 30 bp, Artificial Sequence
  Description of Artificial Sequence Synthetic HIV probe
gggacttaccacaccagacaaaaaacatca

SEQ ID NO: 97 - DNA, 30 bp, Artificial Sequence
  Description of Artificial Sequence Synthetic HIV probe
gaaagaacctccattcctttggatgggtta

SEQ ID NO: 98 - DNA, 30 bp, Artificial Sequence
  Description of Artificial Sequence Synthetic HIV probe
tgaactccatcctgataaatggacagtaca

SEQ ID NO: 99 - DNA, 30 bp, Artificial Sequence
  Description of Artificial Sequence Synthetic HIV probe
gcctatagtgctgccagaaaaagacagctg

SEQ ID NO: 100 - DNA, 30 bp, Artificial Sequence
  Description of Artificial Sequence Synthetic HIV probe
gactgtcaatgacatacagaagttagtggg

SEQ ID NO: 101 - DNA, 30 bp, Artificial Sequence
  Description of Artificial Sequence Synthetic HIV probe
gaaattgaattgggcaagtcagatttaccc

SEQ ID NO: 102 - DNA, 30 bp, Artificial Sequence
  Description of Artificial Sequence Synthetic HIV probe
agggattaaagtaaggcaattatgtaaact

SEQ ID NO: 103 - DNA, 30 bp, Artificial Sequence
  Description of Artificial Sequence Synthetic HIV probe
ccttagaggaaccaaagcactaacagaagt

SEQ ID NO: 104 - DNA, 30 bp, Artificial Sequence
  Description of Artificial Sequence Synthetic HIV probe
aataccactaacagaagaagcagagctaga

SEQ ID NO: 105 - DNA, 30 bp, Artificial Sequence
  Description of Artificial Sequence Synthetic HIV probe
actggcagaaaacagagagattctaaaaga

SEQ ID NO: 106 - DNA, 30 bp, Artificial Sequence
  Description of Artificial Sequence Synthetic HIV probe
accagtacatggagtgtattatgacccatc

SEQ ID NO: 107 - DNA, 30 bp, Artificial Sequence
  Description of Artificial Sequence Synthetic HIV probe
aaaagacttaatagcagaaatacagaagca

SEQ ID NO: 108 - DNA, 30 bp, Artificial Sequence
  Description of Artificial Sequence Synthetic HIV probe
ggggcaaggccaatggacatatcaaattta

SEQ ID NO: 109 - DNA, 30 bp, Artificial Sequence
  Description of Artificial Sequence Synthetic HIV probe
tcaagagccatttaaaaatctgaaaacagg

SEQ ID NO: 110 - DNA, 30 bp, Artificial Sequence
  Description of Artificial Sequence Synthetic HIV probe
aaaatatgcaagaatgaggggtgcccacac

SEQ ID NO: 111 - DNA, 30 bp, Artificial Sequence
  Description of Artificial Sequence Synthetic HIV probe
taatgatgtaaaacaattaacagaggcagt

SEQ ID NO: 112 - DNA, 30 bp, Artificial Sequence
  Description of Artificial Sequence Synthetic HIV probe
gcaaaaaataaccacagaaagcatagtaat

SEQ ID NO: 113 - DNA, 30 bp, Artificial Sequence
  Description of Artificial Sequence Synthetic HIV probe
atggggaaagactcctaaatttaaactgcc

SEQ ID NO: 114 - DNA, 30 bp, Artificial Sequence
  Description of Artificial Sequence Synthetic HIV probe
catacaaaaggaaacatgggaaacatggtg

SEQ ID NO: 115 - DNA, 30 bp, Artificial Sequence
  Description of Artificial Sequence Synthetic HIV probe
gacagagtattggcaagccacctggattcc

SEQ ID NO: 116 - DNA, 30 bp, Artificial Sequence
  Description of Artificial Sequence Synthetic HIV probe
tgagtgggagtttgttaatacccctccctt

SEQ ID NO: 117 - DNA, 30 bp, Artificial Sequence
  Description of Artificial Sequence Synthetic HIV probe
agtgaaattatggtaccagttagagaaaga

SEQ ID NO: 118 - DNA, 30 bp, Artificial Sequence
  Description of Artificial Sequence Synthetic HIV probe
acccatagtaggagcagaaaccttctatgt

SEQ ID NO: 119 - DNA, 30 bp, Artificial Sequence
  Description of Artificial Sequence Synthetic HIV probe
agatggggcagctaacagggagactaaatt

SEQ ID NO: 120 - DNA, 30 bp, Artificial Sequence
  Description of Artificial Sequence Synthetic HIV probe
aggaaaagcaggatatgttactaatagagg

SEQ ID NO: 121 - DNA, 30 bp, Artificial Sequence
  Description of Artificial Sequence Synthetic HIV probe
aagacaaaaagttgtcaccctaactgacac

SEQ ID NO: 122 - DNA, 30 bp, Artificial Sequence
  Description of Artificial Sequence Synthetic HIV probe
aacaaatcagaagactgagttacaagcaat

SEQ ID NO: 123 - DNA, 30 bp, Artificial Sequence
  Description of Artificial Sequence Synthetic HIV probe
ttatctagctttgcaggattcgggattaga

SEQ ID NO: 124 - DNA, 30 bp, Artificial Sequence
  Description of Artificial Sequence Synthetic HIV probe
agtaaacatagtaacagactcacaatatgc

SEQ ID NO: 125 - DNA, 30 bp, Artificial Sequence
  Description of Artificial Sequence Synthetic HIV probe
attaggaatcattcaagcacaaccagatca

SEQ ID NO: 126 - DNA, 30 bp, Artificial Sequence
  Description of Artificial Sequence Synthetic HIV probe
aagtgaatcagagttagtcaatcaaataat

SEQ ID NO: 127 - DNA, 30 bp, Artificial Sequence
  Description of Artificial Sequence Synthetic HIV probe
agagcagttaataaaaaaggaaaaggtcta

SEQ ID NO: 128 - DNA, 30 bp, Artificial Sequence
  Description of Artificial Sequence Synthetic HIV probe
tctggcatgggtaccagcacacaaaggaat

SEQ ID NO: 129 - DNA, 30 bp, Artificial Sequence
  Description of Artificial Sequence Synthetic HIV probe
tggaggaaatgaacaagtagataaattagt

SEQ ID NO: 130 - DNA, 30 bp, Artificial Sequence
  Description of Artificial Sequence Synthetic HIV probe
cagtgctggaatcaggaaagtactattttt

SEQ ID NO: 131 - DNA, 30 bp, Artificial Sequence
  Description of Artificial Sequence Synthetic HIV probe
agatggaatagataaggcccaagatgaaca

SEQ ID NO: 132 - DNA, 30 bp, Artificial Sequence
  Description of Artificial Sequence Synthetic HIV probe
tgagaaatatcacagtaattggagagcaat

SEQ ID NO: 133 - DNA, 30 bp, Artificial Sequence
  Description of Artificial Sequence Synthetic HIV probe
ggctagtgattttaacctgccacctgtagt

SEQ ID NO: 134 - DNA, 30 bp, Artificial Sequence
  Description of Artificial Sequence Synthetic HIV probe
agcaaaagaaatagtagccagctgtgataa

SEQ ID NO: 135 - DNA, 30 bp, Artificial Sequence
  Description of Artificial Sequence Synthetic HIV probe
atgtcagctaaaaggagaagccatgcatgg

SEQ ID NO: 136 - DNA, 30 bp, Artificial Sequence
  Description of Artificial Sequence Synthetic HIV probe
acaagtagactgtagtccaggaatatggca

SEQ ID NO: 137 - DNA, 30 bp, Artificial Sequence
  Description of Artificial Sequence Synthetic HIV probe
actagattgtacacatttagaaggaaaagt

SEQ ID NO: 138 - DNA, 30 bp, Artificial Sequence
  Description of Artificial Sequence Synthetic HIV probe
tatcctggtagcagttcatgtagccagtgg

SEQ ID NO: 139 - DNA, 30 bp, Artificial Sequence
  Description of Artificial Sequence Synthetic HIV probe
atatatagaagcagaagttattccagcaga

SEQ ID NO: 140 - DNA, 30 bp, Artificial Sequence
  Description of Artificial Sequence Synthetic HIV probe
aacagggcaggaaacagcatattttctttt

SEQ ID NO: 141 - DNA, 30 bp, Artificial Sequence
  Description of Artificial Sequence Synthetic HIV probe
aaaattagcaggaagatggccagtaaaaac

SEQ ID NO: 142 - DNA, 30 bp, Artificial Sequence
  Description of Artificial Sequence Synthetic HIV probe
aatacatactgacaatggcagcaatttcac

SEQ ID NO: 143 - DNA, 30 bp, Artificial Sequence
  Description of Artificial Sequence Synthetic HIV probe
cggtgctacggttagggccgcctgttggtg

SEQ ID NO: 144 - DNA, 30 bp, Artificial Sequence
  Description of Artificial Sequence Synthetic HIV probe
ggcgggaatcaagcaggaatttggaattcc

SEQ ID NO: 145 - DNA, 30 bp, Artificial Sequence
  Description of Artificial Sequence Synthetic HIV probe
ctacaatccccaaagtcaaggagtagtaga

SEQ ID NO: 146 - DNA, 30 bp, Artificial Sequence
  Description of Artificial Sequence Synthetic HIV probe
atctatgaataaagaattaaagaaaattat

SEQ ID NO: 147 - DNA, 30 bp, Artificial Sequence
  Description of Artificial Sequence Synthetic HIV probe
aggacaggtaagagatcaggctgaacatct

SEQ ID NO: 148 - DNA, 30 bp, Artificial Sequence
  Description of Artificial Sequence Synthetic HIV probe
taagacagcagtacaaatggcagtattcat

SEQ ID NO: 149 - DNA, 30 bp, Artificial Sequence
  Description of Artificial Sequence Synthetic HIV probe
ccacaattttaaaagaaaaggggggattgg

SEQ ID NO: 150 - DNA, 30 bp, Artificial Sequence
  Description of Artificial Sequence Synthetic HIV probe
ggggtacagtgcaggggaaagaatagtaga

SEQ ID NO: 151 - DNA, 30 bp, Artificial Sequence
  Description of Artificial Sequence Synthetic HIV probe
cataatagcaacagacatacaaactaaaga

SEQ ID NO: 152 - DNA, 30 bp, Artificial Sequence
  Description of Artificial Sequence Synthetic HIV probe
attacaaaaacaaattacaaaaattcaaaa

SEQ ID NO: 153 - DNA, 30 bp, Artificial Sequence
  Description of Artificial Sequence Synthetic HIV probe
ttttcgggtttattacagggacagcagaaa

SEQ ID NO: 154 - DNA, 30 bp, Artificial Sequence
  Description of Artificial Sequence Synthetic HIV probe
tccactttggaaaggaccagcaaagctcct

SEQ ID NO: 155 - DNA, 30 bp, Artificial Sequence
  Description of Artificial Sequence Synthetic HIV probe
ctggaaaggtgaaggggcagtagtaataca

SEQ ID NO: 156 - DNA, 30 bp, Artificial Sequence
  Description of Artificial Sequence Synthetic HIV probe
agataatagtgacataaaagtagtgccaag

SEQ ID NO: 157 - DNA, 30 bp, Artificial Sequence
  Description of Artificial Sequence Synthetic HIV probe
aagaaaagcaaagatcattagggattatgg

SEQ ID NO: 158 - DNA, 30 bp, Artificial Sequence
  Description of Artificial Sequence Synthetic HIV probe
aaaacagatggcaggtgatgattgtgtggc

SEQ ID NO: 159 - DNA, 30 bp, Artificial Sequence
  Description of Artificial Sequence Synthetic HIV probe
aagtagacaggatgaggattagaacatgga

SEQ ID NO: 160 - DNA, 30 bp, Artificial Sequence
  Description of Artificial Sequence Synthetic HIV probe
aaagtttagtaaaacaccatatgtatgttt

SEQ ID NO: 161 - DNA, 30 bp, Artificial Sequence
  Description of Artificial Sequence Synthetic HIV probe
cagggaaagctaggggatggttttatagac

SEQ ID NO: 162 - DNA, 30 bp, Artificial Sequence
  Description of Artificial Sequence Synthetic HIV probe
atcactatgaaagccctcatccaagaataa

SEQ ID NO: 163 - DNA, 30 bp, Artificial Sequence
  Description of Artificial Sequence Synthetic HIV probe
gttcagaagtacacatcccactaggggatg

SEQ ID NO: 164 - DNA, 30 bp, Artificial Sequence
  Description of Artificial Sequence Synthetic HIV probe
ctagattggtaataacaacatattggggtc

SEQ ID NO: 165 - DNA, 30 bp, Artificial Sequence
  Description of Artificial Sequence Synthetic HIV probe
tgcatacaggagaaagagactggcatttgg

SEQ ID NO: 166 - DNA, 30 bp, Artificial Sequence
  Description of Artificial Sequence Synthetic HIV probe
gtcagggagtctccatagaatggaggaaaa

SEQ ID NO: 167 - DNA, 30 bp, Artificial Sequence
  Description of Artificial Sequence Synthetic HIV probe
agagatatagcacacaagtagaccctgaac

SEQ ID NO: 168 - DNA, 30 bp, Artificial Sequence
  Description of Artificial Sequence Synthetic HIV probe
tagcagaccaactaattcatctgtattact

SEQ ID NO: 169 - DNA, 30 bp, Artificial Sequence
  Description of Artificial Sequence Synthetic HIV probe
ttgactgtttttcagactctgctataagaa

SEQ ID NO: 170 - DNA, 30 bp, Artificial Sequence
  Description of Artificial Sequence Synthetic HIV probe
aggccttattaggacacatagttagcccta

SEQ ID NO: 171 - DNA, 30 bp, Artificial Sequence
  Description of Artificial Sequence Synthetic HIV probe
ggtgtgaatatcaagcaggacataacaagg

SEQ ID NO: 172 - DNA, 30 bp, Artificial Sequence
  Description of Artificial Sequence Synthetic HIV probe
taggatctctacaatacttggcactagcag

SEQ ID NO: 173 - DNA, 30 bp, Artificial Sequence
  Description of Artificial Sequence Synthetic HIV probe
cattaataacaccaaaaaagataaagccac

SEQ ID NO: 174 - DNA, 30 bp, Artificial Sequence
  Description of Artificial Sequence Synthetic HIV probe
ctttgcctagtgttacgaaactgacagagg

SEQ ID NO: 175 - DNA, 30 bp, Artificial Sequence
  Description of Artificial Sequence Synthetic HIV probe
atagatggaacaagccccagaagaccaagg

SEQ ID NO: 176 - DNA, 30 bp, Artificial Sequence
  Description of Artificial Sequence Synthetic HIV probe
gccacagagggagccacacaatgaatggac

SEQ ID NO: 177 - DNA, 30 bp, Artificial Sequence
  Description of Artificial Sequence Synthetic HIV probe
actagagcttttagaggagcttaagaatga

SEQ ID NO: 178 - DNA, 30 bp, Artificial Sequence
  Description of Artificial Sequence Synthetic HIV probe
agctgttagacattttcctaggatttggct

SEQ ID NO: 179 - DNA, 30 bp, Artificial Sequence
  Description of Artificial Sequence Synthetic HIV probe
ccatggcttagggcaacatatctatgaaac

SEQ ID NO: 180 - DNA, 30 bp, Artificial Sequence
  Description of Artificial Sequence Synthetic HIV probe
ttatggggatacttgggcaggagtggaagc

SEQ ID NO: 181 - DNA, 30 bp, Artificial Sequence
  Description of Artificial Sequence Synthetic HIV probe
cataataagaattctgcaacaactgctgtt

SEQ ID NO: 182 - DNA, 30 bp, Artificial Sequence
  Description of Artificial Sequence Synthetic HIV probe
tatccattttcagaattgggtgtcgacata

SEQ ID NO: 183 - DNA, 30 bp, Artificial Sequence
  Description of Artificial Sequence Synthetic HIV probe
gcagaataggcgttactcgacagaggagag

SEQ ID NO: 184 - DNA, 30 bp, Artificial Sequence
  Description of Artificial Sequence Synthetic HIV probe
caagaaatggagccagtagatcctagacta

SEQ ID NO: 185 - DNA, 30 bp, Artificial Sequence
  Description of Artificial Sequence Synthetic HIV probe
gagccctggaagcatccaggaagtcagcct

SEQ ID NO: 186 - DNA, 30 bp, Artificial Sequence
  Description of Artificial Sequence Synthetic HIV probe
aaaactgcttgtaccaattgctattgtaaa

SEQ ID NO: 187 - DNA, 30 bp, Artificial Sequence
  Description of Artificial Sequence Synthetic HIV probe
aagtgttgctttcattgccaagtttgtttc

SEQ ID NO: 188 - DNA, 30 bp, Artificial Sequence
  Description of Artificial Sequence Synthetic HIV probe
ataacaaaagccttaggcatctcctatggc

SEQ ID NO: 189 - DNA, 30 bp, Artificial Sequence
  Description of Artificial Sequence Synthetic HIV probe
aggaagaagcggagacagcgacgaagagct

SEQ ID NO: 190 - DNA, 30 bp, Artificial Sequence
  Description of Artificial Sequence Synthetic HIV probe
catcagaacagtcagactcatcaagcttct

SEQ ID NO: 191 - DNA, 30 bp, Artificial Sequence
  Description of Artificial Sequence Synthetic HIV probe
ctatcaaagcagtaagtagtacatgtaatg

SEQ ID NO: 192 - DNA, 30 bp, Artificial Sequence
  Description of Artificial Sequence Synthetic HIV probe
caacctataccaatagtagcaatagtagca

SEQ ID NO: 193 - DNA, 30 bp, Artificial Sequence
  Description of Artificial Sequence Synthetic HIV probe
ttagtagtagcaataataatagcaatagtt

SEQ ID NO: 194 - DNA, 30 bp, Artificial Sequence
  Description of Artificial Sequence Synthetic HIV probe
gtgtggtccatagtaatcatagaatatagg

SEQ ID NO: 195 - DNA, 30 bp, Artificial Sequence
  Description of Artificial Sequence Synthetic HIV probe
aaaatattaagacaaagaaaaatagacagg

SEQ ID NO: 196 - DNA, 30 bp, Artificial Sequence
  Description of Artificial Sequence Synthetic HIV probe
ttaattgatagactaatagaaagagcagaa

SEQ ID NO: 197 - DNA, 30 bp, Artificial Sequence
  Description of Artificial Sequence Synthetic HIV probe
gacagtggcaatgagagtgaaggagaaata

SEQ ID NO: 198 - DNA, 30 bp, Artificial Sequence
  Description of Artificial Sequence Synthetic HIV probe
tcagcacttgtggagatgggggtggagatg

SEQ ID NO: 199 - DNA, 30 bp, Artificial Sequence
  Description of Artificial Sequence Synthetic HIV probe
gggcaccatgctccttgggatgttgatgat

SEQ ID NO: 200 - DNA, 30 bp, Artificial Sequence
  Description of Artificial Sequence Synthetic HIV probe
ctgtagtgctacagaaaaattgtgggtcac

(19) United States
(12) Patent Application Publication
(10) Pub. No.: US 2011/0071044 A1
(43) Pub. Date: Mar. 24, 2011

(54) MICROARRAY AND METHOD OF DESIGNING NEGATIVE CONTROL PROBES

(76) Inventor: Hideki HORIUCHI, Yokohama-shi (JP)

(21) Appl. No.: 12/883,032

(22) Filed: Sep. 15, 2010

Related U.S. Application Data
(63) Continuation of application No. PCT/JP09/53620, filed on Feb. 20, 2009.

(30) Foreign Application Priority Data
Mar. 21, 2008 (JP) 2008-074290

(51) Int. Cl. C40B 30/04; C40B 40/06

(52) U.S. Cl. 506/9; 506/16

(57) ABSTRACT

According to one aspect, a microarray for nucleic acid detection includes a substrate, a negative control probe group immobilized on a first region of the substrate and provided with a plurality of first probes having different sequences, and a second probe immobilized on a second region of the substrate and containing a sequence complementary to a target nucleic acid.

### CROSS REFERENCE TO RELATED APPLICATIONS

This is a Continuation Application of PCT Application No. PCT/JP2009/053620, filed Feb. 20, 2009, which was published under PCT Article 21(2) in English.

This application is based upon and claims the benefit of priority from Japanese Patent Application No. 2008-074290, filed Mar. 21, 2008; the entire contents of which are incorporated herein by reference.

### FIELD

One aspect relates to a microarray provided with negative control probes and a method of designing negative control probes.

### BACKGROUND

In detection with a microarray, a negative control probe (also generally called NC probe) used in evaluating a background signal level should be established (“Baio-Jikken Cho-Kihon Q&A” (Bio-Experimental Super-Fundamentals Q&A), pp. 58-61, Yodosha). Usually, when an NC probe is established, a specific nucleotide sequence unlikely to crossreact with an analyte is selected, then immobilized on a substrate and used in evaluation of a background signal level.

In recent years, it was revealed that gene sequences are dynamically exchanged over the species barrier among animals and plants in a broad range. For example, the integration of a part of a microbial gene sequence in a plant gene can certainly occur. Accordingly, an NC probe obtained by a conventional method of establishing an NC probe, which is designed under the concept that a specific nucleotide sequence unlikely to crossreact with a target to be detected, hardly avoids an unintended crossreaction attributable to exchange of gene sequences over the species barrier.

### BRIEF DESCRIPTION OF THE DRAWINGS

FIG. 1 is a schematic diagram of one aspect of the present invention.

FIG. 2 is graph for showing the principle of the present invention.

FIG. 3 is a graph showing a hybridization signal obtained in one aspect of the present invention.

FIG. 4 is a view showing one aspect of the present invention.

### DETAILED DESCRIPTION

In general, according to one aspect, a microarray for permitting to more accurately evaluate a background signal level is disclosed.

According to one aspect, the followings are provided:

(1) A microarray for nucleic acid detection, which includes a substrate, a negative control probe group immobilized on a first region of the substrate and provided with a plurality of first probes having different sequences, and a second probe immobilized on a second region of the substrate and containing a sequence complementary to a target nucleic acid, wherein the number of types of first probes of the negative control probe group is a number at which a hybridization signal obtained by the reaction between the negative control group and a nucleic acid matching fully with a part of the first probes contained in the negative control group is less than a threshold value; and

(2) A method of designing a negative control probe group contained in the microarray according to (1), which includes measuring a hybridization signal repeatedly by allowing the same analyte to act on microarray having a plurality of first probes applied to a negative control group immobilized on separate regions, determining the maximum value in dispersion among the measured hybridization signals, determining a threshold value by multiplying the maximum value in dispersion by the factor of safety, and determining the concentration of the first probes at which a hybridization signal obtained by reaction with a nucleic acid matching fully with a part of the first probes contained in the negative control group is less than the threshold value.

According to one aspect of the present invention, there is provided a means which can more accurately evaluate a background signal level in a microarray.

The microarray according to one aspect is basically a device for detecting a target nucleic acid with a target nucleic acid detection probe immobilized on a detection probe immobilization region on a substrate. This device is a device that detects a hybridization signal between a target nucleic acid and a target nucleic acid detection probe having a sequence complementary to the target nucleic acid, thereby determining whether the target nucleic acid is present or not in a sample containing a nucleic acid analyte. The microarray according to one aspect is provided not only with the target nucleic acid detection probe but also with a negative control probe group. The negative control probe group is a probe group for detecting a background signal, and this group is immobilized on a negative control probe immobilization region arranged on the surface of a substrate on which the target nucleic acid detection probe has also been immobilized.

As used herein, the term “microarray” is synonymous with generally used terms such as “nucleic acid chip”, “DNA chip” and “DNA array” and is used interchangeably with each other.

The substrate used in one aspect may be a microarray substrate of any type known in the art, such as an electrochemical detection type (typically a current detection type), a fluorescence detection type, a chemiluminescence type or a radioactivity detection type.

Any types of microarrays can be manufactured by any methods known per se. In the case of the current detection type microarray for example, a negative control probe immobilization region and a detection probe immobilization region may be arranged on different electrodes.

As used herein, the “hybridization signal” is a signal generated upon hybridization of a probe with its complementary sequence, and refers collectively to detection signals detected as a current value, fluorescence intensity and luminescence intensity, depending on the detection system of the microarray.

The nucleotide sequence of the negative control probe may be any of artificially randomly synthesized and/or selected nucleotide sequences or may be any of commonly and naturally occurring nucleotide sequences.

The negative control probe according to one aspect may be produced by any methods known per se or may be prepared from naturally occurring nucleic acids. The negative control probe may have some modifications known per se which are necessary for immobilization onto an intended substrate.

In one aspect, there may be provided an assay kit provided independently with a substrate and a negative control probe. In this case, a combination of a detection probe and/or an immobilization reagent may further be provided.

According to one aspect, a background signal level can be evaluated more accurately even if an unintended crossreaction is generated in the case where a nucleic acid analyte that has undergone mutations or genetic recombination is used as a sample.

The detection probe used herein may be composed of any of nucleic acids known per se, or may also have any characteristics known per se.

### First Embodiment of the Invention

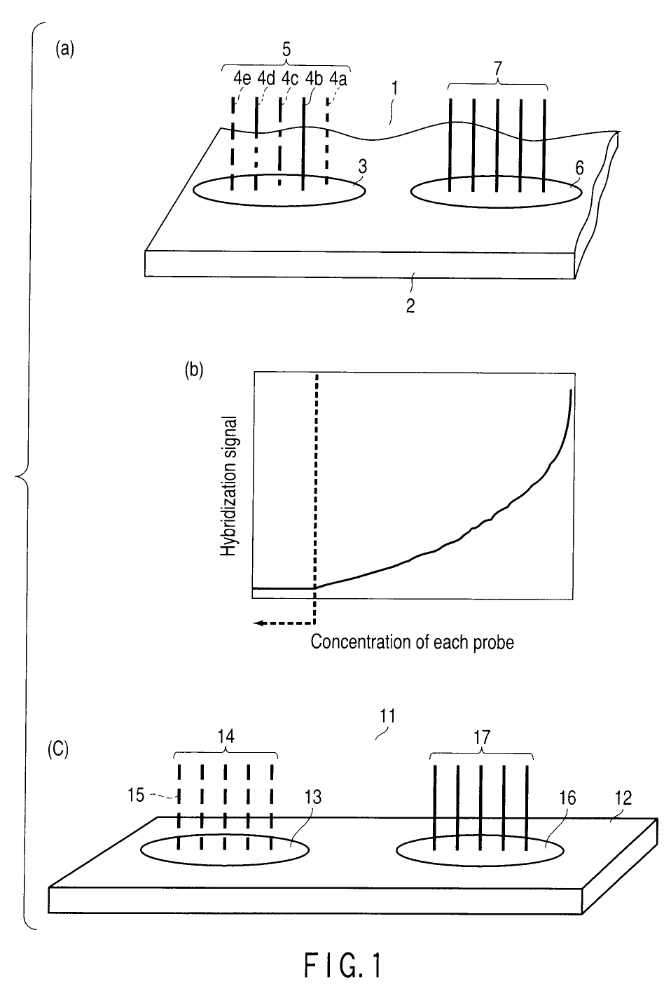

As shown in FIG. 1(a), a microarray 1 is provided with a substrate 2, a negative control probe group 5 having a plurality of first probes 4a to 4x (x: an integer of 2 or more) having different sequences immobilized on a negative control probe immobilization region 3 that is a first region on a first face of the substrate 2, and a second probe 7 consisting of a detection probe immobilized on a detection probe immobilization region 6 that is a second region.

The second probe 7 may be any sequence complementary to a target nucleic acid, and may have for example a sequence complementary to a sequence of a nucleic acid analyte estimated to be present in a sample. When a sample containing a nucleic acid analyte is reacted with the microarray 1, a hybridization signal is generated where the target nucleic acid in the sample is hybridized with the second probe 7. Detection with the microarray 1 can be achieved by detection of this hybridization signal. Although the number of the detection probe immobilization region 6 in FIG. 1 is 1, a plurality of detection probe immobilization regions 6 may further be arranged as third, fourth and fifth regions as in the conventional microarray. In this case, the probes immobilized on each region may have the same sequence or different sequences among the detection probe immobilization regions.

The negative control probe group 5, on one hand, is used to measure a background signal in measurement with each microarray device. The negative control probe group 5 is provided after immobilization on the negative control immobilization region 3 in the microarray. The negative control probe group 5 may be provided by immobilization on a plurality of negative control probe immobilization regions 3.

When more accurate determination of a background signal level is required, the total amount of the negative control probe group 5 immobilized on the negative control immobilization region 3 is desirably an equal amount to that of the second probes immobilized on the detection probe immobilization region 6. The “equal amount” used herein may be for example the amount of the negative control probes in a ratio of from 1/10 or more to 10-fold or less relative to the amount of the second probes.

However, the total amount of the negative control probe group 5 immobilized on the negative control immobilization region 3 may not be an equal amount to that of the second probes immobilized on the detection probe immobilization region 6, but may be immobilized in a predetermined ratio therebetween. The background (or hybridization) signal in this case can be calculated by multiplying a signal obtained from each probe immobilization region by a suitable arbitrary value (for example a reciprocal of the predetermined ratio mentioned above).

For example, when the total amount of the negative control probe group 5 immobilized on the negative control immobilization region 3 is ½ relative to the amount of the second probes immobilized on the detection probe immobilization region 6, then (1) a background signal to be compared with a hybridization signal obtained from the detection probe immobilization region 6 is calculated by doubling a signal obtained from the negative control immobilization region 3. Alternatively, (2) a hybridization signal obtained from the detection probe immobilization region 6 is divided by 2 and then compared with a background signal obtained from the negative control immobilization region 3.

The negative control probe group 5 is composed of plural types of probes that have nucleotide sequences different from one another. That is, the first probe may be a probe group consisting of probes 4a to 4x (x: is an arbitrary integer of 2 or more), and further a plurality of sequences of the same type may also be arranged. Preferably, the nucleotide sequences of probes contained in the first probe are basically different from a sequence complementary to a target nucleic acid to be detected. However, the negative control probes according to one aspect of the present invention are designed such that even if a nucleic acid having a sequence complementary to sequences contained in the negative control probe group is generated by an unintended crossreaction and applied to the negative control probe group, there occurs hybridization signal intensity lower than a threshold value. Accordingly, the sequences of probes contained in the negative control probe group are not necessarily different from a complementary strand of a nucleic acid analyte.

Even if one of the probes constituting the negative control probe group 5 hybridizes with a nucleic acid having a nucleotide sequence fully matching therewith, a hybridization signal is not detected by the negative control probe group 5 as a whole. That is, the negative control probe group 5 is designed to be lower than a threshold value for distinguishing effective signal intensity from signal intensity below it, even if one of plural types of probes contained in the negative control probe group 5 reacts with a sequence fully matching therewith.

Such design can be achieved by increasing the types of probes contained in the negative control group 5. In the hybridization signal (for example, the electrochemical signal, fluorescence signal or chemiluminescence signal) from the negative control probe group 5 immobilized on the negative control immobilization region 3, a hybridization signal generated by an unintended crossreaction in the negative control probe group can be kept low by appropriately increasing the types of nucleotide sequences present in the negative control probe immobilization region 3. For example, an unintended hybridization signal becomes lower as the types of probes contained in the probe control group are increased. This is due to a relatively decreased concentration of one type of nucleotide sequence contained in one negative control probe immobilization region 3, that is, a relatively decreased number of molecules of one type of nucleotide sequence. The negative control probe can thereby function as a definite background. That is, FIG. 1(b) shows that when amount of same type of polynucleotide probe contained in the negative control probe group 5 is lower than a specific concentration, namely a critical concentration or a critical molecular weight (at concentrations on the left side of the dashed arrow in FIG. 1(b)), a hybridization signal has a definite low value even if a fully matching nucleic acid analyte is hybridized. Accordingly, it is important that same type of polynucleotide probe is reduced to such a concentration. By such designing, even if a nucleotide sequence matching fully with a part of nucleic acids contained in a sample is applied as a first probe, the signal from the nucleotide sequence is not detected as a hybridization signal. Accordingly, the negative control probe group 5 as a whole can function as the negative control probe.

A larger number of types of probes contained in the negative control probe group are preferable. As the types of probes contained therein are increased, the probability of generation of false positive signal can be advantageously reduced.

From the following description, it can be appreciated that a larger number of types of probes contained in the negative control probe group are preferable.

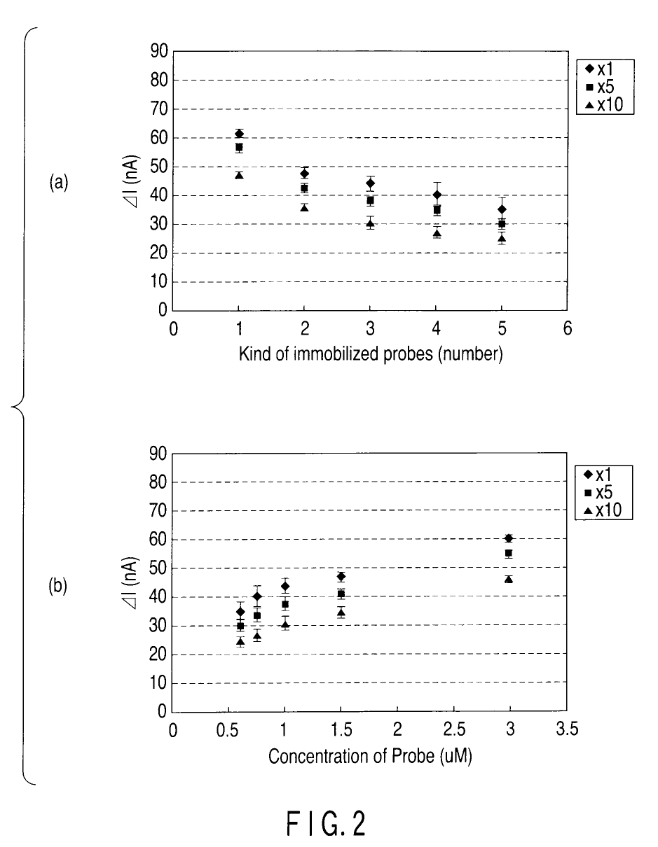

Reference is made to FIG. 2(a). FIG. 2(a) is a graph showing results of detection of a hybridization signal upon reaction of 1 type of probe, with a nucleic acid having 100% complementarity thereto, on a microarray on which a negative control probe group consisting of 1 type, 2 types, 3 types, 4 types and 5 types of probes have been immobilized. Regardless of the number of types of probe sequences constituting the probe group, the amount of the probes as a whole or the number of molecules is the same. In this graph, the number of the types of immobilized probes is shown on the abscissa axis, and the detected hybridization signal is shown on the ordinate axis. As can be seen from the graph, the hybridization signal is decreased as the number of the types of probes contained in the negative control probe group is increased.

Five types of probes are used in this graph, and the respective probes are probes containing any of the polynucleotides shown in SEQ ID NOS: 1 to 5, respectively. That is, one type of the probes used herein is a probe containing the polynucleotide of SEQ ID NO: 1. Two types of probes used herein are a probe containing the polynucleotide of SEQ ID NO: 1 and a probe containing the polynucleotide of SEQ ID NO: 2. Three types of probes used herein are a probe containing the polynucleotide of SEQ ID NO: 1, a probe containing the polynucleotide of SEQ ID NO: 2 and a probe containing the polynucleotide of SEQ ID NO: 3. Four types of probes used herein are a probe containing the polynucleotide of SEQ ID NO: 1, a probe containing the polynucleotide of SEQ ID NO: 2, a probe containing the polynucleotide of SEQ ID NO: 3 and a probe containing the polynucleotide of SEQ ID NO: 4. Five types of probes used herein are a probe containing the polynucleotide of SEQ ID NO: 1, a probe containing the polynucleotide of SEQ ID NO: 2, a probe containing the polynucleotide of SEQ ID NO: 3, a probe containing the polynucleotide of SEQ ID NO: 4 and a probe containing the polynucleotide of SEQ ID NO: 5.

The polynucleotides of SEQ ID NOS: 1 to 5 are polynucleotides derived from a human papillomavirus (expressed as “HPV” in the figure; also referred to hereinafter as “HPV”). The graph in FIG. 2(a) shows the results of analysis wherein these polynucleotides are immobilized on a current detection type microarray, a polynucleotide complementary to SEQ ID NO: 1 is applied as a analyte, and the generated hybridization signal is detected as a current value. In the graph, the solid rhomb shows a current value with the analyte at a concentration of 10¹² copies/ml, the solid square shows a current value with a 5-fold dilution of the sample, and the solid triangle shows a current value with a 10-fold dilution of the sample.

FIG. 2(b) is a graph wherein the above data are shown not by the types of probes, but by the concentration of one type of nucleic acid contained in the negative control probe group. The graph in FIG. 2(b) shows the concentration of one type of focused nucleic acid on the abscissa axis, and the hybridization signal is shown on the ordinate axis.

As can be seen from FIG. 2(b), the hybridization signal is decreased as the concentration is decreased. That is, the types of probes contained in the negative control probe group can be increased to decrease the concentration of same type of probe present therein, thereby decreasing the hybridization signal to be detected. The negative control probe group in accordance with one aspect of the present invention employs such principle according to which probes having different types of sequences are contained in the negative control probe group so that their detected hybridization signal can made lower than effective signal intensity, that is, their signal can be made lower than a predetermined threshold value.

For example, for the types of probes immobilized on the same negative control immobilization region 3, the types of probes to be immobilized on the same region in the same substrate may be for example 3 types or more, 4 types or more, 5 types or more, 6 types or more, 7 types or more, 8 types or more, 9 types or more, 10 types or more, 50 types or more, or 100 types or more, preferably 50 types or more or 60 types or more, more preferably 100 types or more and 4ⁿ types or less wherein n is the number of bases in the probe.

The probes contained in one negative control group may be the same or different in length. However, the probes preferably have the same length as that of the detection probe. The different types of probes may be the same or different in concentration.

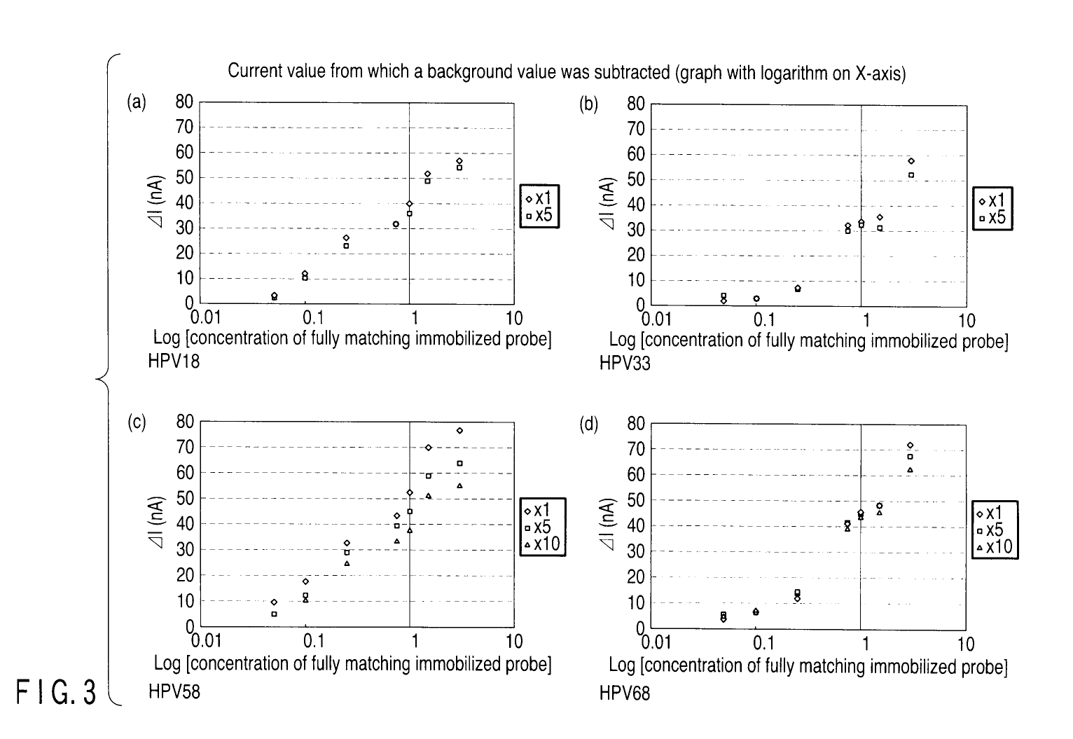

Reference is made to FIG. 3. FIG. 3 shows the results of detection of hybridization signals in terms of current value obtained by reacting 100% complementary target nucleic acid at 2 concentrations, with HPV18 (SEQ ID NO: 1), HPV33 (SEQ ID NO: 2), HPV58 (SEQ ID NO: 3) and HPV68 (SEQ ID NO: 4) as negative control probes immobilized on a substrate of a current detection type microarray. Each probe was dissolved to concentrations of 0.05 μM, 0.1 μM, 0.5 μM, 1 μM, 2 μM and 3 μM in purified water, and 100 nL each of the resulting probe solutions was immobilized on the electrode. Regardless of the type of nucleic acid immobilized, the hybridization signal was decreased as the concentration was decreased.

Accordingly, the probes contained in the negative control group, even when having a sequence matching fully with a nucleic acid analyte, may be immobilized as same type of the probes to be immobilized on the same region, for example at concentrations of 1 μM or less, 0.5 μM or less, preferably 0.1 μM or less or 0.05 μM or less, so as to make the obtained signal intensity lower than effective signal intensity, that is, lower than a specific threshold value. In such immobilization of the negative control group, different types of probes are mixed for example such that the same type of probe therein reaches the concentration described above while the concentration of the total amount of the negative control probes immobilized reaches the same amount as that of the second probes, to prepare a negative control probe group solution which is then used to immobilize the probes on a negative control immobilization region in a substrate. Such negative control probe group solution also falls under the scope of one aspect of the present invention, and may be provided for example as a kit containing the solution.

For rendering the above-described concentrations applicable, the types of different nucleotide sequences to be immobilized on the same region in the same substrate may be for example 3 types or more, 4 types or more, 5 types or more, 6 types or more, 7 types or more, 8 types or more, 9 types or more, 10 types or more, 50 types or more, or 100 types or more, preferably 50 types or more or 60 types or more, more preferably 100 types or more and 4ⁿ types or less wherein n is the number of bases in the probe.

Regardless of the detection type of the microarray, the threshold value can be determined in the following manner. That is, a microarray having plural types of probes immobilized on separate regions is reacted repeatedly with the same analyte complementary to each probe to measure the amount of a hybridization signal. The range of dispersion among the measured values of the amount of hybridization signals repeatedly measured for each probe is determined and the maximum value in the dispersion is multiplied by the factor of safety, thereby determining a threshold value. In this way, the threshold value of any detection type of microarray can be determined.

The concentration of each probe can be determined so as to bring about a hybridization signal lower than the threshold value thus determined. Then, the probes at the respective concentrations may be mixed, or the probes may be mixed so as to attain the respective concentrations, to form the negative control probe group.

In the case of a microarray in a detection mode other than the current detection type, sensitivity may vary depending on the mode. In this case too, a threshold value is determined by the method described above, and probes of types necessary for a hybridization signal below than the threshold value are mixed to prepare a negative control group. Alternatively, the concentration of probes necessary for a hybridization signal lower than the threshold value is determined as a critical concentration, and the probes containing plural types of polynucleotides are mixed to be a concentration lower than the critical concentration, to form a negative control probe group on the substrate.

One aspect also provides a method of designing the negative control probe group. An example of the method is as follows: First, the same analyte is repeatedly measured with a microarray having plural types of probes immobilized on separate regions, to determine the range of dispersion among the measurements of the amount of hybridization signals. Then, the maximum value in the dispersion thus determined is multiplied by the factor of safety depending on the measurement means, to determine a threshold value. Then, the concentration condition of probes is determined at which the amount of hybridization signal upon application of 100% complementarity strand thereto is lower than the threshold value. The concentration of plural types of probes is selected so as to meet the condition. In this manner, the negative control probe group can be designed. Such a design method can be applied to the negative control group on a microarray of any detection type known per se. The factor of safety is a multiplying factor for a numerical value under use conditions, relative to the upper limit for use determined from theoretical values and experiments.

The results of detection with the microarray may be calculated by subtracting a hybridization signal obtained from the negative control immobilization region, from a hybridization signal obtained from the detection probe immobilization region.

### Second Embodiment

In a further embodiment, a microarray 11 as shown in FIG. 1(c) comprises a substrate 12, a first probe 14 that is a negative control probe immobilized on a negative control probe immobilization region 13 as a first region, and a second probe 17 that is a detection probe immobilized on a detection probe immobilization region 16 as a second region.

The second probe 17 similar to the second probe in the first embodiment has a sequence complementary to a target nucleic acid, for example, a sequence complementary to a nucleic acid analyte estimated to be present in an analyte. When a target nucleic acid in a nucleic acid-containing analyte is hybridized with the second probe 17 upon reaction of the analyte with the microarray 11, a hybridization signal is generated. By detecting this hybridization signal, detection with the microarray 11 is achieved. The obtained data are subjected to processing of subtracting a hybridization signal as a background obtained from the negative control probe, from the obtained data. Although only 1 detection probe immobilization region 16 is shown in FIG. 1(c), a plurality of detection probe immobilization regions 16 may be arranged as in the conventional microarray, and the detection probes immobilized thereon may have the same sequence or different sequences among the respective regions.

As described above, the first probe 14 that is a negative control probe is used in determining a background in measurement with each microarray device. The negative control probe 14 is provided after immobilization on the negative control probe immobilization region 13 of the microarray.

The negative control probe 14 is a polynucleotide having a nucleotide 15 having a modified base.

The “modified base” used herein refers to a base having a modification not causing a nucleotide sequence-specific hybridization with a base moiety constituting a nucleotide. Such a modified base includes, but is not limited to, 2′-deoxyinosine and 2′-deoxynebularine. By using the modified base, a signal from a crossreaction with a fully matching nucleotide sequence contained is not detected as a hybridization signal, so the negative control probe can fulfill its role.

The negative control probes immobilized on the same negative control immobilization region 13 may be modified base-containing polynucleotides consisting of plural types of nucleotides or modified base-containing polynucleotides consisting of nucleotides of the same type.

The modified base-containing polynucleotide provided as the negative control probe in the present embodiment may be synthesized by methods known per se. The probe may also be provided as one having any modifications known per se which are necessary for immobilization onto an intended substrate. The probes contained in one negative control may be the same or different in length. However, the probes preferably have the same length as that of the detection probe. The different types of probes may be the same or different in concentration.

The result detected from the microarray may be determined by subtracting the amount of a hybridization signal obtained from the negative control immobilization region, from the amount of a hybridization signal obtained from the detection probe immobilization region.

### EXAMPLES

Hereinafter, some aspects of this application are described in more detail by reference to the Examples.

### Example 1

An example is described in which a current detection type nucleic acid chip was used as a microarray and a 30-mer probe was used as a negative control probe. In this system, a threshold value for judgment of an effective signal was set at 15 nA or more, assuming that a week signal amplification of less than 15 nA was within the range of measurement errors.

First for examining the conditions of the amount of nucleic acids and/or the number of molecules at the level where an effective hybridization signal was not given, 200 types of 30-mer synthetic oligonucleic acids having different sequences were mixed to prepare a negative control probe group. These nucleotide sequences are set forth in SEQ ID NOS: 1 to 200 of sequence listing. For immobilization onto a microarray substrate provided with gold electrodes, these probes were those into which a thiol group had been introduced at the 3′-terminal thereof.

As the substrate, a glass substrate provided with a plurality of gold electrodes was prepared.

Any probes were prepared such that the final concentration of the whole nucleic acids reached 3 μM. One polynucleotide having one type of nucleotide sequence was dissolved to be a concentration of 3 μM in sterilized distilled water. Similarly, 2 types of polynucleotides (SEQ ID NOS: 1 and 2) were prepared to be a final concentration of 1.5 μM respectively so that the final concentration of the nucleic acids in total (that is, the total concentration of the 2 polynucleotide) reached 3 μM. Further, solutions each containing 3 types (SEQ ID NOS: 1 to 3) to 200 types (SEQ ID NOS: 1 to 200) of polynucleotides were prepared to be a final concentration of 3 μM in terms of the total concentration of nucleic acids respectively. That is, one to plural types of polynucleotides were used to prepare a series of probe mixtures containing serially increasing types of probes. The resulting nucleic acid solutions different in the number of mixed probes were dropped onto different gold electrodes on the same substrate. The substrate was left at ordinary temperatures for 1 hour, then washed with water and dried to immobilize the probes on the gold electrodes.

Separately, an about 200-mer nucleic acid fragment having a sequence with 100% complementarity to one of 200 types of the probes which was contained in common among the mixed solutions was prepared and used as a target nucleic acid.

Each probe solution was used to immobilize the probes on the substrate to prepare a microarray, and then the target nucleic acid to which 20×SSC buffer had been added in an amount of 1/9 was dropped onto the microarray and then subjected to hybridization at 35° C. for 1 hour.

After hybridization, the substrate was washed with 0.2×SSC for 15 minutes, and finally a current response of Hoechst 33258 was measured.

In a control section, a nucleic acid sequence not complementary to any of the probe sequences immobilized on the substrate was applied as a control nucleic acid, and a current value was obtained from the each electrode by a similar reaction to obtain data. The data were used as the background for calculating an increase in the amount of current upon hybridization with the target. As a result, when the concentration of the target probes having 100% complementarity with the target nucleic acid was about 0.05 μM or less in the probe nucleic acid mixed solution, that is, when about 60 types or more of nucleic acid species were mixed, the resulting signal intensity was lower than the threshold value in any combinations of the probes with the target nucleic acid to be evaluated, and it was thus confirmed that an effective hybridization signal cannot be generated.

Given this evaluation result, the virus nucleic acid detection probes were mixed such that the concentration of the respective sequences in the probe nucleic acid mixed solution was 0.05 μM or less, to prepare probe immobilization electrodes as a test section.

On the other hand, the target nucleic acid containing a sequence complementary to the probe was mixed with 20×SSC buffer in an amount of 1/9, to prepare a solution at a final concentration of 10¹² copies/mL which was then dropped onto each of the probe immobilization electrodes. The specimen was hybridized at 35° C. for 1 hour and washed with 0.2×SSC for 15 minutes. Thereafter, a current response of Hoechst 33258 was measured. As the control section, electrodes each having one type of probe immobilized at a concentration of 3 μM were also prepared on the same substrate. As a result, a significant increase in the current value was observed in the control section. On the other hand, an increase in the current value and a signal attributable to hybridization were not observed in the test section.

This example showed an example of using a current detection type nucleic acid chip, but the application of the aspect is not limited thereto and can be applied to nucleic acid chips in other detection systems, specifically a fluorescence detection system, a chemiluminescence system, and a beads array.

An example was shown in which a virus-derived sequence was used as an object in the example, but as a matter of course, the application of the aspect is not limited thereto. An example where a 30-mer synthetic oligonucleic acid was used as a probe is shown, but the length and sequence of the probe and its immobilization method may be appropriately selected depending on the detection object and intended use, and are not limited to those under the conditions described in this example. A probe of different length may be mixed as necessary.

From the foregoing, it was revealed that according to the method of one aspect, the negative control probe group can be prevented from generating an effective hybridization signal even if a target nucleic acid having a sequence that is 100% complementary to one of the probes, is used as analyte thus making it possible to provide a negative control probe group that can accurately evaluate a background signal level.

This example shows a method wherein a plurality of probe sequences are mixed to determine the amount of nucleic acids and/or the number of molecules at the level where an effective hybridization signal is not given. However, it requires labor to actually mix many types of probes. For simplifying the operation, only one type of probe sequence may be focused as an object by using relatively few types (e.g. 2 types or so), followed by changing the concentration of the objective probe, or the number of molecules, in the probe mixed solution; in this manner, the same results as with the mixed probes used with a varying number of types thereof have been confirmed to be obtainable.

### Example 2

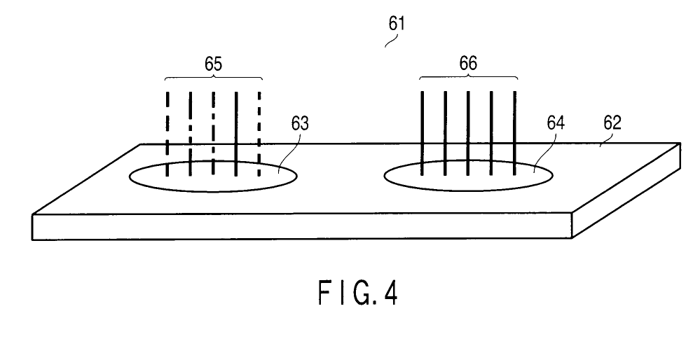

As shown in FIG. 4, the negative control probe group 65 obtained in Example 1 was immobilized onto a negative control immobilization region 63 on a substrate 62 in a current detection type microarray 61. Further, a detection probe 66 was immobilized onto a detection probe immobilization region 64. The microarray in accordance with one aspect was thereby provided.

### Example 3

A 30-mer synthetic oligonucleic acid having 2′-deoxyinosine and 2′-deoxynebularine as bases and having a thiol group introduced into its 3′-terminal for immobilization was prepared as a negative control probe. This negative control probe having the modified nucleic acids as constituent nucleic acids was dissolved at a concentration of 3 μM in sterilized distilled water.

Separately, a glass substrate provided with a plurality of gold electrodes was prepared as a substrate of a microarray.

The 3 μM negative control probe solution was dropped onto the gold electrodes, left at ordinary temperatures for 1 hour, washed with water and dried. A microarray provided with the negative control probe was thereby obtained.

Target nucleic acids consisting of various sequences were mixed with 1/9 volume of 20×SSC buffer to prepare a solution at a final concentration of 10¹² copies/mL. The resulting solution was dropped onto the microarray provided with the negative control probe prepared above, and a current response of Hoechst 33258 was measured. As a result, an increase in the current value was not observed even when any targets were applied. That is, a signal attributable to hybridization between the negative control probe and the targets was not observed.

This example shows an example of using a current detection type nucleic acid chip, but according to one aspect, nucleic acid chips in other detection systems, for example a fluorescence detection type chip, a chemiluminescence type chip and a beads array, are also provided as the microarray having a significant effect according to one aspect.

An example of using a 30-mer synthetic oligonucleic acid as a probe is shown therein, but the length of the probe and the type of modified nucleic acid may be appropriately selected depending on the detection object and intended use, and are not limited to those under the conditions described in this example. Probes different in length and in nucleic acid type may be mixed as necessary.

From the foregoing, it was revealed that according to the method of one aspect, the negative control probe group can be prevented from generating an effective hybridization signal upon crossreaction, even if a analyte containing a target nucleic acid having 100% complementarity with the probe is used as a sample. A negative control probe that can accurately evaluate a background signal level was thereby provided.

### Example 4

As shown in FIG. 1(c), the negative control probe 14 obtained in Example 3 was immobilized onto the negative control region 13 on substrate 12 in the current detection type microarray 11. Further, the detection probe 17 was immobilized onto the detection probe region 16. The microarray in accordance with one aspect was thereby provided.

### Example 5

A current detection type nucleic acid chip was used as a microarray to determine a threshold value.

First, 15 types of 30-mer synthetic oligonucleic acids having different sequences with a thiol group introduced into the 3′-terminal thereof were prepared as probes. As the substrate, a glass substrate provided with a plurality of metal electrodes was prepared.

The probes having any sequences were prepared such that the total nucleic acid concentration reached final concentration of 3 μM, and these probe solutions were dropped on different gold electrodes on the same substrate. The substrate was left at ordinary temperatures for 1 hour, washed with water and dried, thereby providing a current detection type nucleic acid microarray having the probes immobilized on the gold electrodes.

Then, a nucleic acid that was 100% complementary to each probe sequence immobilized on the DNA chip was dissolved to 10 concentrations (10², 10⁴, 10⁶, 10⁸, 10¹⁰, 10¹², 10¹⁴, 10¹⁶, 10¹⁸, and 10²⁰ copies/ml) in 1/9 volume of 20×SSC buffer, and the resulting solutions were dropped onto the microarray and hybridized at 35° C. for 1 hour.

After hybridization, the microarray was washed with 0.2×SSC for 15 minutes, and finally a current response of Hoechst 33258 was measured. Each experimental section was measured repeatedly at least 50 times, and the reproducibility of measurement results and the fluctuation in measurements attributable to the characteristics of the device itself were evaluated.

In a control section, a nucleic acid sequence not complementary to any of the probe sequences immobilized on the substrate was applied as a control nucleic acid. A current value was obtained from the each electrode by a similar reaction to obtain data. The data were used as the background for calculating an increase in the amount of current upon hybridization with the target.

As a result, the range of dispersion in current signals obtained from the respective probes was 10 nA or less in any combinations of the probes and the target to be evaluated.

A microarray using sequences (200 types or more of sequences) other than the probes and targets described above was also similarly evaluated. As a result of evaluation of the reproducibility of measurement results and the fluctuation in measurements attributable to the characteristics of the device itself, it was confirmed that when this device was used, the maximum fluctuation in signals was 10 nA.

Because the actually used environment can comprise considerable uncertainty, designing having allowance to a certain degree is necessary. Accordingly, the fluctuation measurement of 10 nA obtained above was multiplied by 1.5 as the factor of safety, and the obtained value, that is, 15 nA, was established as the threshold value of the hybridization signal.

Given this evaluation result, a weak increase in signal of less than 15 nA was considered to be within the range of measurement errors. That is, the threshold value for judgment of an effective hybridization signal was set at 15 nA.

This example shows an example of using a current detection type nucleic acid chip, but the present invention is not limited thereto and can be applied to nucleic acid chips in other detection systems, specifically in a fluorescence detection system and a chemiluminescence system, or to a beads array. The range of dispersion, the factor of safety and the like vary depending on conditions such as the device structure, the principle of the measurement system, and the measurement object.

The above example shows an example of using a virus-derived sequence as the subject, but the sequence that can be used in establishing a threshold value is not limited thereto. An example of using a 30-mer synthetic oligonucleic acid as the probe is shown herein, but the length and sequence of the probe may be appropriately selected depending on the detection object and intended use, and are not limited to those under the conditions described in this example. A probe of different length may be mixed as necessary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A microarray for nucleic acid detection, which comprises a substrate, a negative control probe group immobilized on a first region of the substrate and provided with a plurality of first probes having different sequences, and a second probe immobilized on a second region of the substrate and containing a sequence complementary to a target nucleic acid, wherein the number of types of first probes of the negative control probe group is a number at which a hybridization signal obtained by the reaction between the negative control group and a nucleic acid matching fully with a part of the first probes contained in the negative control group is less than a threshold value.

2. The microarray according to claim 1, wherein the nucleotide sequences of the first probes are sequences different from the nucleotide sequence of the second probe.

3. The microarray according to claim 1, wherein the microarray is selected from the group consisting of an electrochemical detection type, a fluorescence detection type, a chemiluminescence type and a radioactivity detection type.

4. The microarray according to claim 3, wherein the microarray is an electrochemical detection type, the first region is on a first electrode, and the second region is on a second electrode.

5. A method of designing a negative control probe group contained in the microarray according to claim 1, which comprises measuring a hybridization signal repeatedly by allowing the same analyte to act on a microarray having a plurality of first probes applied to a negative control group immobilized on separate regions, determining the maximum value in dispersion among the measured hybridization signals, determining a threshold value by multiplying the maximum value in dispersion by the factor of safety, and determining the concentration of the first probes at which a hybridization signal obtained by reaction with a nucleic acid matching fully with a part of the first probes contained in the negative control group is less than the threshold value.

6. A microarray comprising a substrate, a negative control probe provided with a polynucleotide immobilized on a first region of the substrate, and a second probe immobilized on a second region of the substrate and containing a sequence complementary to a target nucleic acid, wherein the negative control probe is a modified base-containing polynucleotide not contributing to nucleotide sequence-specific hybridization.

7. The microarray according to claim 6, wherein the negative control probe is a polynucleotide having a nucleotide with a modified base bound to the 1′-position of its pentose.

8. The microarray according to claim 6, wherein the modified base is selected from the group consisting of 2′-deoxyinosine and 2′-deoxynebularine.
